(19) United States
(12) Patent Application Publication
(10) Pub. No.: US 2006/0285598 A1
(43) Pub. Date: Dec. 21, 2006

(54) Apparatuses, computer program product and method for digital image quality improvement

(76) Inventor: Jarno Tulkki, Kempele (FI)

Correspondence Address: YOUNG & THOMPSON, 745 SOUTH 23RD STREET, 2ND FLOOR, ARLINGTON, VA, 22202, US

(21) Appl. No.: 11/154,643

(22) Filed: Jun. 17, 2005

(51) Int. Cl. H04N 11/04; H04N 7/12; H04N 11/02; H04B 1/66

(52) U.S. Cl. 375/240.18; 375/240.24; 375/240.12

(57) ABSTRACT

Apparatuses, a computer program product and a method for digital image quality improvement. A digital image quality improvement unit includes an input interface to obtain edge pixels of a pixel domain target block and edge pixels of pixel domain blocks adjacent to the pixel domain target block; a processing unit coupled with the input interface to form a frequency domain substitute block from the edge pixels of the pixel domain target block and the edge pixels of the pixel domain blocks adjacent to the pixel domain target block and to form a pixel domain substitute block from the frequency domain substitute block; and an output interface coupled with the processing unit to place the pixel domain substitute block in position of the pixel domain target block.

### FIELD

The invention relates to a digital image quality improvement unit, an arrangement for digital image quality improvement, a computer program product for digital image quality improvement, embodied on a distribution medium, an integrated digital image quality improvement circuit, and a method for improving digital image quality.

### BACKGROUND

Digital images are typically still images or a video sequence made of individual successive still images or frames. Various compression methods have long been used in storing and transmitting digital image signals because of the large information capacity of the image signals. An example of a compression method is a standard known as MPEG-4 (Moving Picture Experts Group). Also other compression methods are available.

A raw or an uncompressed digital image comprises pixel matrices, which may be in different color formats, RGB or YCbCr, for instance. The image encoding compresses the signal into a binary bit stream, which may be transmitted or stored in a memory. When the signal is utilized, i.e. received or read from the memory, it is decoded back to the uncompressed form.

In image encoding, a single frame is typically divided into blocks whose size or even shape may vary by the used coding standard. Frames are then encoded block-by-block, and frame-by-frame. In compression, the individual character of single frames and blocks is lost, since they become dependent on each other, mainly for the sake of motion estimation, but also for the sake of other coding methods.

In digital image transmission, errors are typical in a bit stream and especially error bursts can ruin the entire compressed bit stream because of the aforementioned dependency. Therefore, different error correction or concealing methods are needed in a decoder. As the encoded image data has been transmitted in blocks, the error concealment solutions detect an erroneous block in the frame data and typically predict the content of the erroneous block, which is then added to the frame data.

There are numerous prior art methods for concealing the error blocks. The methods usually depend on the coding standard used. Roughly, these methods can be divided into four categories.

In post processing methods, missing pixel data is simply interpolated from surrounding uncorrupted pixels. These methods require heavy calculation and the result may not be so desirable. U.S. Pat. No. 6,134,352 discloses an example of the post processing methods In error block replacement methods, an erroneous block is replaced as a function of the previous frame. The function may be a motion vector or a prediction of it. U.S. Pat. No. 5,910,827 discloses an example of the error block replacement methods. When consecutive frames remain unchanged, the methods work well, but for a fast changing sequence these methods lose their power.

In frequency domain concealment methods, an erroneous block is modified while decoding it. Typically the dc coefficient of an erroneous block is set to a local dominant level, whereby the replacement block will be flat. These methods require least computations, but the result may not always be the best. U.S. Pat. No. 6,404,817 discloses an example of the frequency domain concealment methods.

In motion estimation methods, a motion estimation algorithm is used to seek the best correspondence to a missing block from a previous frame. The motion estimation methods demand heavy calculation and a large amount of new processing logic for the decoder. U.S. Pat. No. 6,512,795 discloses an example of the motion estimation methods.

### BRIEF DESCRIPTION OF THE INVENTION

The present invention seeks to provide an improved digital image quality improvement unit, an improved arrangement for digital image quality improvement, an improved computer program product for digital image quality improvement, embodied on a distribution medium, an improved integrated digital image quality improvement circuit, and an improved method for improving digital image quality.

According to an aspect of the invention, there is provided a digital image quality improvement unit, comprising: an input interface to obtain edge pixels of a pixel domain target block and edge pixels of pixel domain blocks adjacent to the pixel domain target block; a processing unit coupled with the input interface to form a frequency domain substitute block from the edge pixels of the pixel domain target block and the edge pixels of the pixel domain blocks adjacent to the pixel domain target block and to form a pixel domain substitute block from the frequency domain substitute block; and an output interface coupled with the processing unit to place the pixel domain substitute block in position of the pixel domain target block.

According to another aspect of the invention, there is provided an arrangement for digital image quality improvement, comprising: means for obtaining edge pixels of a pixel domain target block and edge pixels of pixel domain blocks adjacent to the pixel domain target block; means for forming a frequency domain substitute block from the edge pixels of the pixel domain target block and the edge pixels of the pixel domain blocks adjacent to the pixel domain target block; means for forming a pixel domain substitute block from the frequency domain substitute block; and means for placing the pixel domain substitute block in position of the pixel domain target block.

According to another aspect of the invention, there is provided a computer program product for digital image quality improvement, embodied on a distribution medium, comprising: an input module to obtain edge pixels of a pixel domain target block and edge pixels of pixel domain blocks adjacent to the pixel domain target block; a computing module coupled with the input module to form a frequency domain substitute block from the edge pixels of the pixel domain target block and the edge pixels of the pixel domain blocks adjacent to the pixel domain target block and to form a pixel domain substitute block from the frequency domain substitute block; and an output module coupled with the computing module to place the pixel domain substitute block in position of the pixel domain target block.

According to another aspect of the invention, there is provided an integrated digital image quality improvement circuit comprising: an input block to obtain edge pixels of a pixel domain target block and edge pixels of pixel domain blocks adjacent to the pixel domain target block; a computing block coupled with the input block to form a frequency domain substitute block from the edge pixels of the pixel domain target block and the edge pixels of the pixel domain blocks adjacent to the pixel domain target block and to form a pixel domain substitute block from the frequency domain substitute block; and an output block coupled with the computing block to place the pixel domain substitute block in position of the pixel domain target block.

According to another aspect of the invention, there is provided a method for improving digital image quality, comprising: obtaining edge pixels of a pixel domain target block and edge pixels of pixel domain blocks adjacent to the pixel domain target block; forming a frequency domain substitute block from the edge pixels of the pixel domain target block and the edge pixels of the pixel domain blocks adjacent to the pixel domain target block; forming a pixel domain substitute block from the frequency domain substitute block; and placing the pixel domain substitute block in position of the pixel domain target block.

The invention provides several advantages. It provides combined error concealment and post processing, which both have traditionally been carried out separately. It provides error concealment and post processing in a frequency domain, which is a much more efficient way to achieve fine image quality as compared to traditional pixel domain based methods. The invention offers a fast and reliable solution to error concealment and post processing in image encoding and decoding without needing extra memory buffers.

### LIST OF DRAWINGS

In the following, the invention will be described in greater detail with reference to the embodiments and the accompanying drawings, in which

FIG. 1 illustrates a digital image decoder;

FIG. 2 illustrates a discrete cosine transformed matrix;

FIGS. 3A, 3B, 3C and 3D illustrate the discrete cosine function coefficient vectors;

FIG. 4 illustrates edge pixels of a pixel domain target block and edge pixels of pixel domain blocks adjacent to the pixel domain target block;

FIG. 5 illustrates scaling; and

FIG. 6 is a flow chart illustrating one embodiment of a method for improving image quality in digital image decoding.

### DESCRIPTION OF PREFERRED EMBODIMENTS

Digital image encoding and decoding are well known to a person skilled in the art from standards and textbooks. Embodiments of digital image encoders and/or decoders are also disclosed in the Applicant's publications: WO 02/33979 A1, WO 02/062072 A1, WO 02/067590 A1, WO 02/078327 A1, and WO 03/043342 A1, incorporated herein as references.

A camera may form a matrix presenting the images as pixels, where different color channels, luminance and chrominance, for instance, may have separate matrices. The data flow that represents the images as pixels is supplied to an encoder, which compresses the data into a transmittable bit stream with a certain compression method, such as MPEG4. The compressed bit stream is then transmitted to a decoder along a channel, in which errors may be generated. The channel may be, for example, a fixed or a wireless data transmission connection. The channel may also be interpreted as a transmission path which is used for storing the image in a memory means, e.g. on a laser disc, and by means of which the image is read from the memory means and processed in the decoder. Next, the decoder decompresses the transmitted bit stream. In principle, the decoder performs the same functions as the encoder when it forms an image but inversely. The encoder and decoder may be arranged in different devices, such as computers, subscriber terminals of different radio systems, e.g. mobile stations, or in other devices where images are to be processed. The encoder and decoder can also be combined to form an image codec.

Digital images to be encoded are typically still images or a video sequence made of individual successive images. A single image is encoded as blocks, and the coding type may be “inter” or “intra”. An intra block is independent as it is encoded individually and it is supposed to be added to the frame as it is. So an intra block has basically only the pixel data. An inter block is encoded with a motion vector from another frame, typically previous, and it is supposed to form the pixel data with the block that the motion vector points to. The inter block has the vector data and the pixel data.

Some embodiments will be explained within the framework of the MPEG-4 video coding, but the embodiments are not restricted thereto.

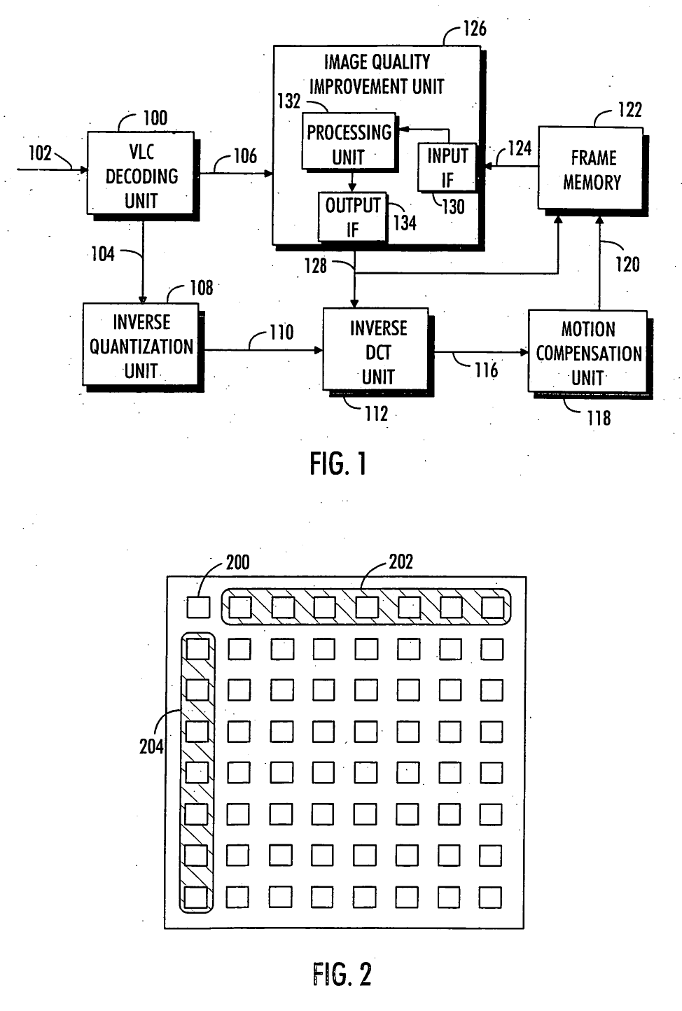

FIG. 1 describes the function of a video decoder on a theoretical level. In practice, the structure of the decoder will be more complicated since a person skilled in the art adds necessary prior art features to it. The encoded bit flow 102 is supplied from a channel to a VLC decoding (VLC=Variable-Length Coding) unit 100 including all processing from a bit stream reception up to but not including the inverse quantization. After VLC decoding, the bit flow 104 proceeds to an inverse quantization unit 108 and further flows 110 to an inverse transformation unit 112. Different standards offer different solutions to the transform, but, in general, the transform is a function from the pixel domain to the frequency domain. For example, MPEG-4 offers the DCT (Discrete Cosine Transform):

$$\begin{matrix}F ( u , v ) = \frac{2}{N} C ( u ) C ( v ) {\sum }_{x} {\sum }_{y} f ( x , y ) cos \\ \frac{( 2 x + 1 ) u π}{2 N} cos \frac{( 2 y + 1 ) v π}{2 N} ,\end{matrix} \qquad ( 1 )$$

where F(u,v) is the transformed value, f(x,y) is the pixel value, N is the block size, and
C(u)=1/\sqrt{2} for u=0 and C(u)=1 otherwise,
C(v)=1/\sqrt{2} for v=0 and C(v)=1 otherwise.

A motion compensation unit 118 gets the decoded pixel data 116, and motion vector data in the inter case, from the inverse transformation unit 112. With the motion vector, the motion compensation 118 unit gets 120 the addressed block of another frame from a frame memory 122, combines these two blocks and adds the result to the present frame in the frame memory 122.

A digital image quality improvement unit 126 comprises an input interface 130 to obtain 124 edge pixels of a pixel domain target block and edge pixels of pixel domain blocks adjacent to the pixel domain target block. The digital image quality improvement unit 126 also comprises a processing unit 132 coupled with the input interface 130 to form a frequency domain substitute block from the edge pixels of the pixel domain target block and the edge pixels of the pixel domain blocks adjacent to the pixel domain target block, and form a pixel domain substitute block from the frequency domain substitute block. The digital image quality improvement unit 126 also comprises an output interface 134 coupled with the processing unit 132 to place 128 the pixel domain substitute block in position of the pixel domain target block.

In an embodiment, the digital image quality improvement unit operates in a post processing mode for improving the quality of (often uncorrupted) digital images. The post processing mode may be implemented in connection with the digital image decoding, as illustrated in FIG. 1. However, the post processing mode may also be implemented in connection with the digital image encoding, as the end of the encoding loop is identical to decoding, described in FIG. 1. In another embodiment, the digital image quality improvement unit operates in an error concealing mode for improving the quality of (often corrupted) digital images.

The output interface 134 may place the pixel domain substitute block in position of the pixel domain target block such that the pixel domain substitute block replaces the pixel domain target block. As an alternative, the output interface 134 may place the pixel domain substitute block in position of the pixel domain target block such that the pixel domain substitute block is added to the pixel domain target block. The former alternative may especially be used in the error concealing mode, the latter especially in the post processing mode.

In an embodiment, the digital image quality improvement unit 126 receives information 106 on an upcoming erroneous block from the VLC decoder unit 100 by means of a further input interface (not illustrated). As soon as the surroundings of the erroneous block have been filled into the frame memory 122, the digital image quality improvement unit 126 studies the edges of the adjacent blocks and creates a substitute block in a frequency domain, which is then conveyed 128 to the inverse transformation unit 112, where the substitute block is changed back into the pixel domain. Finally, the motion compensation unit 118 puts the substitute block in the right place in the frame memory 122. Thus, the processing unit 132, in order to form the pixel domain substitute block from the formed frequency domain substitute block, may utilize the inverse transformation unit 112. The output interface 134, in order to place the pixel domain substitute block in position of the pixel domain target block, may (indirectly as illustrated, or directly) be coupled with the motion compensation unit 118.

The decoder units, or blocks, shown in FIG. 1 may be implemented as one or more integrated circuits, such as application-specific integrated circuits ASIC. Other embodiments are also feasible, such as a circuit built of separate logic components, or a processor with its software. A hybrid of these different embodiments is also feasible. When selecting the method of implementation, a person skilled in the art will consider the requirements set on the size and power consumption of the device, necessary processing capacity, production costs and production volumes, for example. One embodiment is a computer program product for digital image quality improvement, embodied on a distribution medium. In that case, the described decoder units may be implemented as software modules. The distribution medium may be any means for distributing the software to customers, such as a (computer readable) program storage medium, a (computer readable) memory, a (computer readable) software distribution package, a (computer readable) signal, or a (computer readable) telecommunications signal.

FIG. 2 illustrates an example of the frequency domain matrix where the block size N is 8. The element F(0,0) 200 in the upper left corner corresponds to a dc coefficient, which describes the “flat” frequency of the transformed block. Other elements correspond to ac coefficients. The elements 202 to the right of the dc coefficient 200 represent horizontal frequencies and the elements 204 below the dc coefficient 200 represent vertical frequencies. The other elements are combinations of horizontal and vertical frequency components. The frequency represented by each element increases the further the element is from the dc component 200.

The DCT equation (1) may be divided into two terms: a “prefix part”

$$\frac{2}{N} C ( u ) C ( v ) \qquad ( 2 )$$

and a “postfix part”

$$cos \frac{( 2 x + 1 ) u π}{2 N} cos \frac{( 2 y + 1 ) v π}{2 N} . \qquad ( 3 )$$

There are three different “prefix” coefficients

$$\frac{1}{N} , \frac{2}{\sqrt{2} N} and \frac{2}{N}$$

and since N=8 they become

$$1 / 8 for F ( 0 , 0 ) , \\ \frac{1}{4 \sqrt{2}} for F ( 0 , 1 ) and F ( 1 , 0 ) , and$$

$$\frac{1}{4} for all the other elements .$$

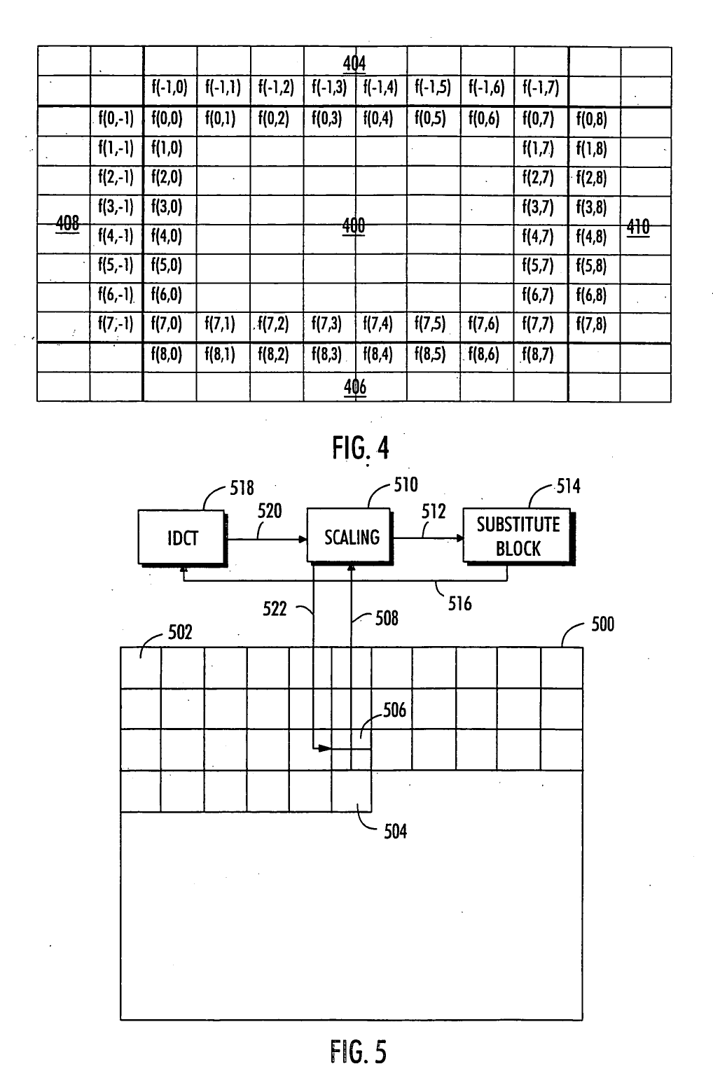

Since x and y run from 0 to 7, the top, left, right and bottom edges of the block, i.e. elements from f(0,0) to f(0,7), from f(0,0) to f(7,0), from f(0,7) to f(7,7) and from f(7,0) to f(7,7) as FIG. 4 illustrates, the postfix part (3) can be calculated beforehand forming different trigonometric waves:

F(0,0): The postfix part becomes 1 for every f(x,y). As a vector it can be described as

v₀={1, 1, 1, 1, 1, 1, 1, 1}

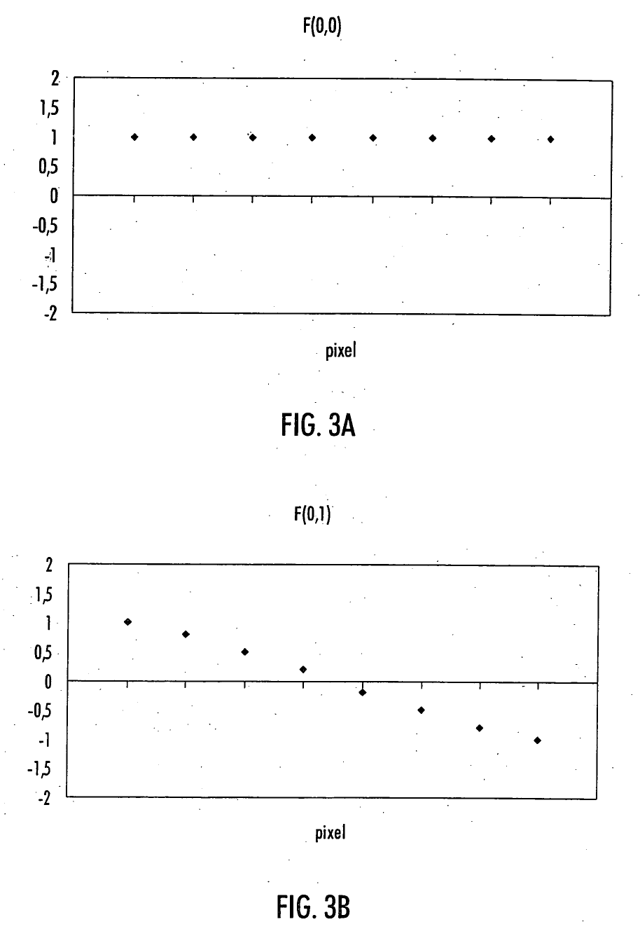

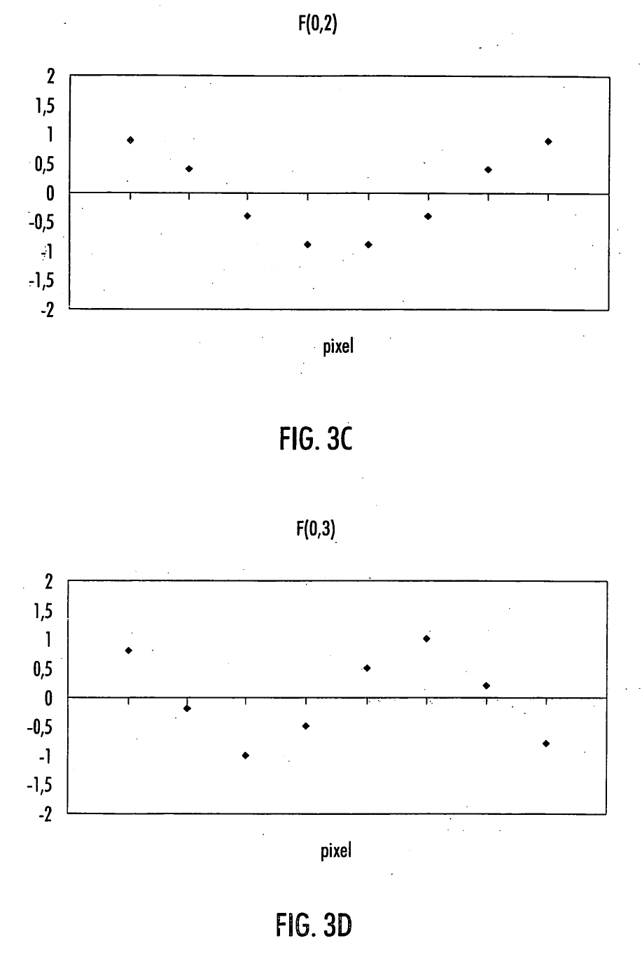

for every edge. This is a coefficient vector for every edge of the “flat frequency” dc coefficient. A graph of it is illustrated in FIG. 3A.

F(0,1): Left edge is v0 and right edge is −v0. Top and bottom edges become

$${v}_{1} = cos \{ \frac{π}{16} , \frac{3 π}{16} , \frac{5 π}{16} , \frac{7 π}{16} , \frac{9 π}{16} , \frac{11 π}{16} , \frac{13 π}{16} , \frac{15 π}{16} \} ,$$

as illustrated in FIG. 3B.

F(0,2) has the vectors v0 and

$${v}_{2} = cos \{ \frac{2 π}{16} , \frac{6 π}{16} , \frac{10 π}{16} , \frac{14 π}{16} , \frac{18 π}{16} , \frac{22 π}{16} , \frac{26 π}{16} , \frac{30 π}{16} \} ,$$

as illustrated in FIG. 3C.

F(0,3) has the vectors v0, −v0 and

$${v}_{3} = cos \{ \frac{3 π}{16} , \frac{9 π}{16} , \frac{15 π}{16} , \frac{21 π}{16} , \frac{27 π}{16} , \frac{33 π}{16} , \frac{39 π}{16} , \frac{45 π}{16} \}$$

as illustrated in FIG. 3D.

So, there will be only 8 different vectors and their negatives. The approximates of the previous vectors v₀-v₃ are

v₀={1, 1, 1, 1, 1, 1, 1, 1},

v₁={1, 0.8, 0.5, 0.2, −0.2, −0.5, −0.8, −1},

v₂={0.9, 0.4, −0.4, −0.9, −0,9, −0.4, 0.4, 0,9},

v₃={0.8, −0.2, −1, −0.5, 0.5, 1, 0.2, −0.8}.

FIG. 4 illustrates edge pixels of a pixel domain target block 400 and edge pixels of pixel domain blocks 404, 406, 408, 410 adjacent to the pixel domain target block 400. F(u,v)'s are calculated from pixel values f(x,y), where x,y runs from 0 to 7, and the substitute blocks F(u,v)'s are calculated from difference of pixel pairs around the edges. For example, the pixels of the top edge are f(0,0)=f(0,0)−f(−1,0), f(0,1)=f(0,1)−f(−1,1), f(0,2)=f(0,2)−f(−1,2), etc.

Now the edge values f′(x,y) may be expressed as repair vectors r₀ to r₃:

$${r}_{j} [ l ] = \{ \begin{matrix}f ( - 1 , i ) - f ( 0 , i ) , for j = 0 \\ f ( 8 , i ) - f ( 7 , i ) , for j = 1 \\ f ( i , - 1 ) - f ( i , 0 ) , for j = 2 \\ f ( i , 8 ) - f ( i , 7 ) , for j = 3\end{matrix}$$

and, further, the elements F(u,v) of the substitute block by

F(0, 0)=c₀(Σv₀r₀+Σv₀r₁+Σv₀r₂+Σv₀r₃)

F(0, 1)=c₁(Σv₁r₀+Σv₁r₁+Σv₀r₂−Σv₀r₃),

F(0, 2)=c₂(Σv₂r₀+Σv₂r₁+Σv₀r₂+Σv₀r₃),

F(0, 3)=c₂(Σv₃r₀+Σv₃r₁+Σv₀r₂−Σv₀r₃),

F(1, 0)=c₁(Σv₀r₀−Σv₀r₁+Σv₁r₂+Σv₁r₃),

F(1, 1)=c₂(Σv₁r₀−Σv₁r₁+Σv₁r₂−Σv₁r₃),

F(1, 2)=c₂(Σv₂r₀−Σv₂r₁+Σv₁r₂+Σv₁r₃),

F(1, 3)=c₂(Σv₃r₀−Σv₃r₁+Σv₁r₂−Σv₁r₃),

F(2, 0)=c₂(Σv₀r₀+Σv₀r₁+Σv₂r₂+Σv₂r₃),

F(2, 1)=c₂(Σv₁r₀+Σv₁r₁+Σv₂r₂−Σv₂r₃),

F(3, 0)=c₂(Σv₀r₀−Σv₀r₁+Σv₃r₂+Σv₃r₃),

F(3, 1)=c₂(Σv₁r₀−Σv₁r₁+Σv₃r₂−Σv₃r₃),

. . . ,

where cᵢ is a prefix coefficient (2) modified (doubled) into 32 elements instead of 64, that is the block's number of pixels. Sometimes pixels of an adjacent block may be missing, but the substitute block is still formable from other edges, only the prefix coefficient has to be modified according to the current pixel number. Also, it is noteworthy that when using post processing, there may be a need for lowering the effect of the substitute block and thus the prefix coefficient has to be alterable for the current situation.

The computation of all the elements F(u,v) may not be needed, since the information on the block's internal higher frequencies is very difficult to trace from the surrounding blocks. Tests performed by the Applicant revealed that the previously mentioned 12 frequencies did quite well, while the effect of the higher frequencies on the image quality was low already. The rest of the elements may be given a zero value.

The error concealing mode takes place when an erroneous block arrives. Then, the block space is supposed to be an empty space, where all the pixels are at zero level (typically this is automatically so). Only “healthy”, i.e. properly decoded or already concealed, edges are used for forming the substitute block. While the coding typically uses macro blocks, each of which contains four luminance and two chrominance blocks, the luminance part is firstly concealed as one block. This may be done in several ways, for example by down sampling the 16×16 block to 8×8 block and then concealing it as a whole. This procedure is illustrated in FIG. 5: The decoder is processing a qcif-sized frame 500, which comprises 11×9 macro blocks 502 of 16×16 pixels. As soon as the macro block 504 has been decoded, the macro block's 506 surroundings can be taken 508 into a scaling procedure 510, wherein the edge vectors of the macro block will be scaled into half of the original length. After that, the normal procedure follows: The vectors are taken 512 into substitute block forming 514, where a frequency domain substitute block is computed for the macro block 506. The substitute block is taken 516 into an IDCT phase 518, where a pixel domain substitute block is computed. Afterwards, it will be taken 520 again into the scaling phase 510, wherein the block will be enlarged back into the size of 16×16 pixels. Finally, the substitute block will be placed 522 into its proper location. After this, for an even better quality, every block inside the macro block 506 can be processed independently.

The post processing mode does not suppose the block to be empty, and thus it can also be used for error concealment purposes, when, for example, motion vectors are not lost and the reference block has been brought from another frame. When running the post processing, a frame will be processed block by block, if necessary, with a properly set prefix coefficient.

The described error concealing/post processing efficiently removes the blocking effect, staircase effect, color bleeding and other typical artifacts of image coding and it even restores details already lost.

A method for improving digital image quality comprises: obtaining edge pixels of a pixel domain target block and edge pixels of pixel domain blocks adjacent to the pixel domain target block; forming a frequency domain substitute block from the edge pixels of the pixel domain target block and the edge pixels of the pixel domain blocks adjacent to the pixel domain target block; forming a pixel domain substitute block from the frequency domain substitute block; and placing the pixel domain substitute block in position of the pixel domain target block.

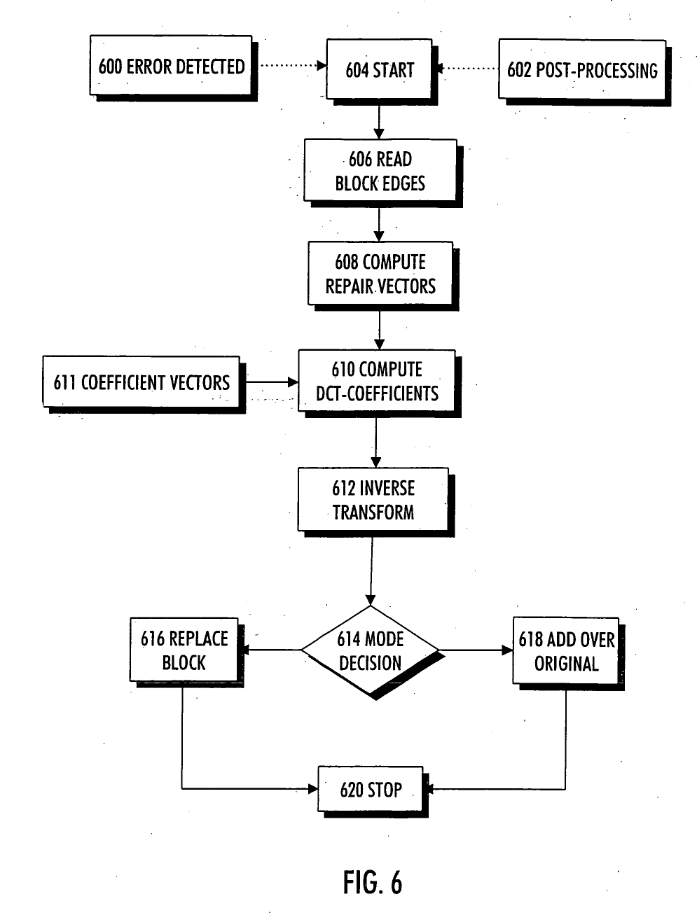

In the following, one embodiment of the method for improving digital image quality will be described with reference to FIG. 6, which describes the processing of one block. Starting instructions 604 come from error detection 600 or post processing 602. First, the edges of the block are read 606 from which the repair vectors (r₀-r₃) are formed 608. Next, the forming of DCT block coefficients 610 takes place with pre-calculated coefficient vectors vᵢ 611 and maybe with adjusted prefix coefficients. Next, the DCT block is inverse transformed 612 into the pixel domain and the inserting mode of the procedure is decided 614: the erroneous block is replaced 616 with a substitute block in the error concealing/intra block case; or the substitute block is added over the original block 618 in the error concealing/inter block case (the motion vectors remains undestroyed) or in the post processing case. Finally, the method is stopped 620.

Even though the invention is described above with reference to an example according to the accompanying drawings, it is clear that the invention is not restricted thereto but it can be modified in several ways within the scope of the appended claims.

1. A digital image quality improvement unit, comprising:
an input interface to obtain edge pixels of a pixel domain target block and edge pixels of pixel domain blocks adjacent to the pixel domain target block;
a processing unit coupled with the input interface to form a frequency domain substitute block from the edge pixels of the pixel domain target block and the edge pixels of the pixel domain blocks adjacent to the pixel domain target block and to form a pixel domain substitute block from the frequency domain substitute block; and
an output interface coupled with the processing unit to place the pixel domain substitute block in position of the pixel domain target block.

2. The digital image quality improvement unit of claim 1, wherein the processing unit, to form the pixel domain substitute block from the formed frequency domain substitute block, further utilizes an inverse transformation unit of a digital image decoder.

3. The digital image quality improvement unit of claim 1, wherein the output interface, to place the pixel domain substitute block in position of the pixel domain target block, is further coupled with a motion compensation unit of a digital image decoder.

4. The digital image quality improvement unit of claim 1, wherein the processing unit further forms the frequency domain substitute block for a set of target blocks and scales the frequency domain substitute block into a set of pixel domain substitute blocks.

5. The digital image quality improvement unit of claim 1, wherein the processing unit further adjusts a prefix coefficient of the frequency domain substitute block.

6. The digital image quality improvement unit of claim 1, wherein the output interface places the pixel domain substitute block in position of the pixel domain target block such that the pixel domain substitute block replaces the pixel domain target block.

7. The digital image quality improvement unit of claim 1, wherein the output interface places the pixel domain substitute block in position of the pixel domain target block such that the pixel domain substitute block is added to the pixel domain target block.

8. The digital image quality improvement unit of claim 1, further operating in a post processing mode for improving the quality of uncorrupted digital images.

9. The digital image quality improvement unit of claim 1, further operating in an error concealing mode for improving the quality of corrupted digital images.

10. An arrangement for digital image quality improvement, comprising:
means for obtaining edge pixels of a pixel domain target block and edge pixels of pixel domain blocks adjacent to the pixel domain target block;
means for forming a frequency domain substitute block from the edge pixels of the pixel domain target block and the edge pixels of the pixel domain blocks adjacent to the pixel domain target block;
means for forming a pixel domain substitute block from the frequency domain substitute block; and
means for placing the pixel domain substitute block in position of the pixel domain target block.

11. A computer program product for digital image quality improvement, embodied on a distribution medium, comprising:
an input module to obtain edge pixels of a pixel domain target block and edge pixels of pixel domain blocks adjacent to the pixel domain target block;
a computing module coupled with the input module to form a frequency domain substitute block from the edge pixels of the pixel domain target block and the edge pixels of the pixel domain blocks adjacent to the pixel domain target block and to form a pixel domain substitute block from the frequency domain substitute block; and
an output module coupled with the computing module to place the pixel domain substitute block in position of the pixel domain target block.

12. An integrated digital image quality improvement circuit comprising:
an input block to obtain edge pixels of a pixel domain target block and edge pixels of pixel domain blocks adjacent to the pixel domain target block;
a computing block coupled with the input block to form a frequency domain substitute block from the edge pixels of the pixel domain target block and the edge pixels of the pixel domain blocks adjacent to the pixel domain target block and to form a pixel domain substitute block from the frequency domain substitute block; and
an output block coupled with the computing block to place the pixel domain substitute block in position of the pixel domain target block.

13. A method for improving digital image quality, comprising:
obtaining edge pixels of a pixel domain target block and edge pixels of pixel domain blocks adjacent to the pixel domain target block;
forming a frequency domain substitute block from the edge pixels of the pixel domain target block and the edge pixels of the pixel domain blocks adjacent to the pixel domain target block;
forming a pixel domain substitute block from the frequency domain substitute block; and
placing the pixel domain substitute block in position of the pixel domain target block.
